(19) United States
(12) Patent Application Publication
(10) Pub. No.: US 2005/0204286 A1
(43) Pub. Date: Sep. 15, 2005

(54) Speech receiving device and viseme extraction method and apparatus

(76) Inventor: Eric R. Buhrke, Clarendon Hills, IL (US)

Correspondence Address: MOTOROLA, INC., 1303 EAST ALGONQUIN ROAD, IL01/3RD, SCHAUMBURG, IL, 60196, US

(21) Appl. No.: 10/797,992

(22) Filed: Mar. 11, 2004

(51) Int. Cl. G10L 11/04

(52) U.S. Cl. 715/706

(57) ABSTRACT

A technique for extracting visemes includes receiving successive frames of digitized analog speech information obtained from the speech signal at a fixed rate (210), filtering each of the successive frames of digitized analog speech information to synchronously generate time domain frame classification vectors at the fixed rate (215, 220, 225, 230, 235, 240), and analyzing each of the time domain classification vectors (250) to synchronously generate a set of visemes corresponding to each of the successive frames of digitized speech information at the fixed rate. Each of the time domain frame classification vectors is derived from one of the successive frames of digitized analog speech information. N multi-taper discrete prolate spheroid sequence basis (MTDPSSB) functions (220) that are factors of a Fredholm integral of the first kind may be used for the filtering, and the analyzing may use a spatial classification function (250). The latency is less than 100 milliseconds.

### FIELD OF THE INVENTION

This invention relates to manipulation of a presentation of a model of a head to simulate the motion that would be expected during the simultaneous presentation of voice, and in particular to determining visemes to use for simulating the motion of the head from messages received in speech form.

### BACKGROUND

The use of a model of a head that is manipulated to mimic the motions expected of a typical person (known as an avatar) during speech is well known. Such models are widely used in animated movies. They have also been used to present an avatar in a client communication device such as a networked computer or a telecommunication device that mimics the motion of a head during the presentation of speech that is synthesized from a text message or from a digitally encoded (compressed) voice message. The animation for these forms of avatars has been generated in an off-line computation. The use of such avatars enhances the communication experience for the user and can help the user interpret the message in situations where the user is in a noisy environment. An avatar would provide an improved communication experience for a user of a portable communication device such as a cellular telephone when a real time voice message is being received, but the conventional methods mentioned above require too much computation(and have unacceptable response time latency) to allow an adequate mimicry to be presented in such devices.

### BRIEF DESCRIPTION OF THE DRAWINGS

The present invention is illustrated by way of example and not limitation in the accompanying figures, in which like references indicate similar elements, and in which:

FIG. 1 is a block diagram that shows a speech communication system in accordance with some embodiments of the present invention; and

FIG. 2 is a block diagram showing portions of a speech receiving device in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular technique for extracting visemes in accordance with the present invention, it should be observed that the present invention resides primarily in combinations of method steps and apparatus components related to viseme extraction. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

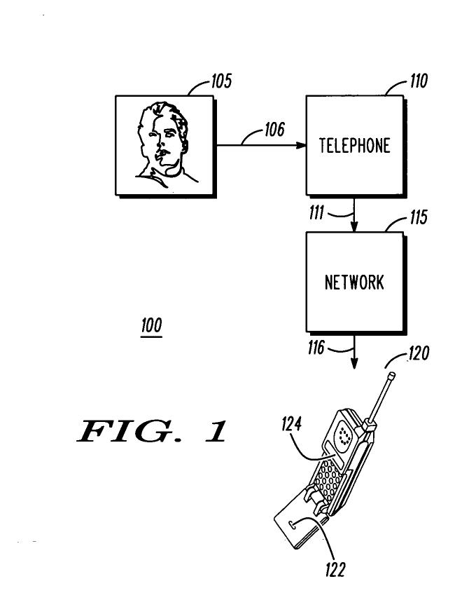

Referring to FIG. 1, a block diagram shows a speech communication system 100 in accordance with some embodiments of the present invention. The speech communication system 100 may be a cellular telephone communication system or another type of communication system. For example, the speech communication system 100 may be a Nextel® communication system, a private radio or landline communication system, or a public safety communication system. In other examples, the speech communication system 100 may be a voice-over-IP communication system, a plain old telephone (switched analog) system (POTS), or a family radio service (FRS) communication system. In the communication system 100, a user 105 may speak into a speech transmitting device 110 that is electronic and that may be a conventional cellular telephone in one embodiment. The speech transmitting device 110 converts the user's speech audio signal 106 into an inbound electronic signal 111 that in a cellular telephone system is a coded, compressed digital signal that carries the speech information. However, in other systems that may also benefit from the present invention, the inbound electronic signal 111 could be sent as an analog electronic signal that carries the speech information. The speech information in the inbound electronic signal 111 is transported by a network 115 to a speech receiving device 120 by an outbound electronic signal 116. The speech receiving device 120 is electronic and comprises a speaker 122 and a display 124. The network 115 may be a conventional cellular telephone network and may modify the inbound electronic signal 111 into outbound electronic signal 116. The speech receiving device 120 may be a conventional cellular telephone. In other communication systems, the speech transmitting and receiving devices 110, 120 may be other types of electronic devices, such as analog telephone desksets, digital private exchange desksets, FRS radios, public safety radios, and NextTel® radios. In the case of a speech communication system 100 for transmitting and receiving devices 110, 120 that can communicate directly with each other, the network 115 may not exist and the inbound electronic signal 111 would be the same as the outbound electronic signal 116. The speech receiving device 120 receives the outbound electronic signal 116 and converts the speech information in the outbound speech signal into a digitally sampled speech signal This aspect may be an inherent function in many of the examples described herein, but would be an added function for the embodiments of the present invention that do not include such a conversion, such as a deskset for a POTS. The speech receiving device 120 receives the speech information in the outbound electronic signal 116 and presents the speech information to a user through the speaker 122. The speech receiving device 120 has stored therein a still image of a head that is modified by the speech receiving device 120 in a unique manner to present an image of the head that moves in synchronism with the speech that is being presented in such a way as to represent the natural movements of the lips and associated parts of the face during the speech. Such a moving head is called an avatar. The movements are generated by determining visemes (lip and facial positions) that are appropriate for the speech being presented. While avatars and visemes are known, the present invention uniquely determines the visemes from the speech as the speech information is being received, in a synchronous manner with very little latency, so that received voice messages are presented without noticeable delay.

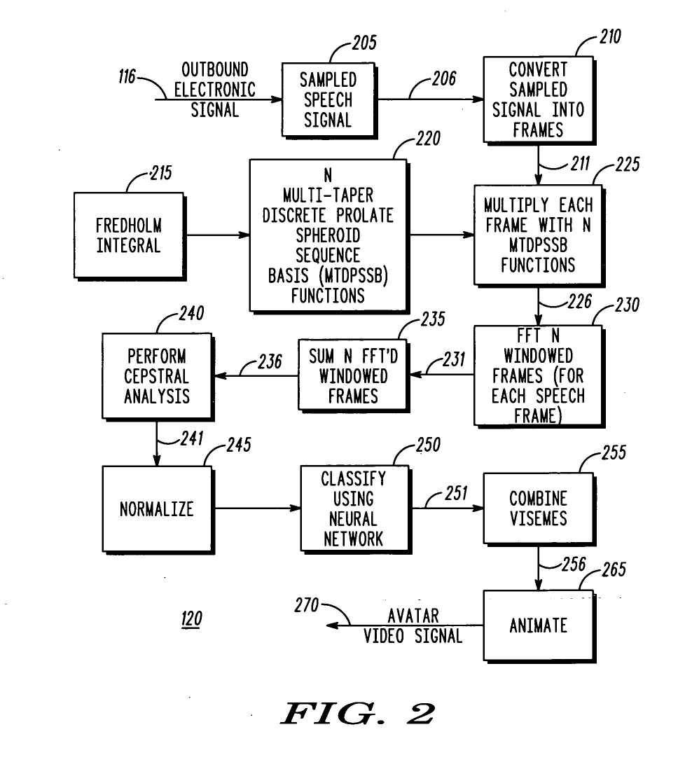

Referring to FIG. 2, a block diagram of portions of the speech receiving device 120 are shown in accordance with some embodiments of the present invention. As indicated above, the speech information in the outbound electronic signal 116 is converted (if necessary) to a conventional digitized analog speech signal 206 by sampled speech signal function 205, at a synchronous sampling rate. The digitized analog speech signal 206 is arranged by a frame function 210 into successive frames of digitized analog speech information 211 at a fixed rate. In accordance with some embodiments of the present invention, the frames 211 are 10 milliseconds long and each frame 211 includes 80 digitized samples of speech information.

Within the speech receiving device 120 is stored a set of N functions 220. Each function is a multi-taper discrete prolate spheroid sequence basis (MTDPSSB) function that is obtained by factoring a Fredholm integral 215, and each function is orthogonal to all the other N-1 functions, as is known in the art of mathematics. Each function is a set of values that may be used to multiply the digitized speech values in a frame of digitized analog speech information 211, which is performed by a multiply function 225. This may be alternatively stated as multiplying a successive frame of digitized analog speech information by one of the N MTDPSSB functions 220 to generate N product sets 226 of the successive frame of digitized analog speech information. This operation may be a dot product operation, so that each of the N product sets includes as many values as there are digitized samples in a frame 211 of speech information, which in the example described herein may be 80. It will be appreciated that the N MTDPSSB functions 220 may be stored in non-volatile memory, in which case a mathematical expression of the Fredholm integral 215 need not be stored in the receiving electronic device 120. In a situation, for example, in which the receiving speech device 120 had to conform to differing digitized speech sampling rates or speech bandwidths, it could be that storing the Fredholm integral expression 215 and deriving the N MTDPSSB functions would be more beneficial than storing the functions. A fast Fourier transform (FFT) of each of the N product sets 226 may then be performed by a FFT function 230, generating N FFT sets 231 for each of the successive frames of digitized analog speech information. The quantity of values in each of the N FFT sets 231 may in general be different than the quantity of digitized speech samples in each frame 211. In the example used herein, the quantity of values in each of the N FFT sets 231 is denoted by K which is 128. The magnitudes of the N FFT sets 231 are added together by a sum function 235 to generate a summed FFT set of the successive frame of digitized analog speech information, which may also be linearly scaled by the sum function 235 to generate a spectral domain vector 236. The operations described thus far may be mathematically expressed as

$$S ( ω ) = G {\sum }_{n} \vert {\sum }_{k} {V}_{nk} {x}_{k} {ⅇ}^{- jω k} \vert , wherein$$

S(ω) is the resulting spectral domain vector 236, which has K (128) elements;
Xₖ is the value of the k^{th} digitized speech sample in the current frame;
Vₙₖ is the k^{th} value of the n^{th} (of N) MTDPSSB functions; and
G is a normalizing factor that is an inverse of the sum of the eigenvalues of the Fredholm integral expansion

The vertical bars represent the magnitude operation.

Thus, each successive frame of digitized analog speech information is uniquely converted to a spectral domain vector 236 by the MTDPSSB, multiply, sum, and FFT functions 220, 225, 230, 235. A Cepstral function 240 performs a conventional transformation of the unique spectral domain vector 236. This involves performing a logarithmic scaling of the spectral domain vector 236, followed by a conventional inverse discrete cosine transformation (IDCT) of the unique spectral domain vector 236. Although a Cepstral function is described in this example, other speech analysis techniques such as auditory filters could be used. The resulting time domain classification vectors 241, which in this example are Cepstral vectors, may be described as having been generated by filtering each of the successive frames of digitized analog speech information to synchronously generate time domain frame classification vectors at the fixed rate, wherein each of the time domain frame classification vectors is derived from one of the successive frames of digitized analog speech information. Each of the time domain classification vectors 241 may be scaled by a normalizing function 245, to provide time domain classification vectors that are compatible in magnitude with a classifying function 250 that analyzes the time domain classification vectors to synchronously generate a set of visemes corresponding to each of the successive frames of digitized speech information at the fixed rate. The classifying function 250 may be a memory-less classifying function that provides as an output 251 based only on the value of the time domain classification vector 241 derived from the most current frame 211. In this example the classifying function 250 is a feed-forward memory-less perceptron type neural classifier, but other memoryless classifiers, such as other types of neural networks or a fuzzy logic network, could alternatively be used. The output 251 in this example is a set of visemes comprising a subset of viseme identifiers and a corresponding subset of confidence numbers that identify the relative confidence of each viseme identifier appearing in the set, but the output 251 may alternatively be simply the identity of the most likely viseme. When the output 251 is a set of visemes, a combine function 255 combines the images of the visemes in the set of visemes to generate a resultant viseme 256. When the output 251 is the most probable viseme, the combine function is bypassed (or not included in the speech receiving device 120) and the resultant viseme 256 is the same as the most likely viseme, which is coupled to an animate function 265 that generates new video images based on the previous video images and the resultant viseme, forming an avatar video signal 270 that is coupled to the display 124 of the speech receiving device 120.

It will be appreciated that the use of the MTDPSSB, multiply, sum, and FFT functions 220, 225, 230, 235 to convert each successive frame of digitized speech information 211 to a spectral domain vector 236 in some embodiments of the present invention is substantially different than the conventional techniques used for converting windows of digitized speech information in speech recognition systems. In order to obtain good results, conventional speech recognition devices perform an FFT on windows of digitized speech information that are equivalent to approximately 6 frames of digitized speech information. For the digitization rate described in the example given above, 512 digitized samples could be used in a conventional speech recognition system; which could, for example, consist of 80 samples from the current frame, 216 samples from the three most recent frames, and 216 samples from the next two successive frames. The complexity of such frame conversion processing is proportional to a factor that is on the order of M log (M), wherein M is the number of samples.

For the present invention, it has been found that using more than five functions (N=5) does not substantially improve the probability of correctly determining the set of visemes. The complexity of such filtering is proportional to a factor on the order of N * M log (M). For N=5 and M=80 the ratio of the complexity of the conventional speech recognition device described above and the viseme extraction device according to the present invention is approximately 1.8 to 1. It will be appreciated, then, that the complexity of the frame conversion processing in the present invention is substantially less than for conventional speech recognition systems. It will be further appreciated that the N multiplications and N FFTs can be done in parallel, achieving more speed improvement in some embodiments, and that because the MTDPSSB functions only depend upon the digitized samples of the current frame 211, the latency of determining the spectral domain vector 236 is determined primarily by the speed at which the functions 220, 225, 230, 235 can be performed, not on the duration of multiple frames. This speed is expected to be less than the frame duration of the example used above (10 milliseconds), for speech receiving devices having currently typical processing circuitry.

It will be further appreciated that in contrast to the hidden Markov model (HMM) techniques used in conventional speech recognition systems, which typically use the time domain vectors determined for at least several frames of digitized speech information, and which may be characterized as temporal classification techniques, the classification function 250 of the present invention may use a spatial classification function that is memoryless, i.e., dependent only upon the time domain frame classification vector of the current frame of digitized speech information 211. Similar to the situation described above, the latency of the classification is dependent only on the speed of the classification function 250, not on a duration of multiple frames 211. This speed is expected to be substantially less than the frame duration of the example used above (10 milliseconds), for speech receiving devices having currently typical processing circuitry.

Inasmuch as the functions of the speech receiving device 120 other than those just mentioned (functions 220, 225, 230, 235, and 250) may be implemented without frame dependent latency and which can be performed quite quickly by processors used in conventional speech receiving devices, the overall latency of the avatar video signal with reference to a frame of digitized speech information may be substantially less than 100 milliseconds, and even less than 10 milliseconds, which means that the speech audio presentation may be presented in real time along with an avatar that mimics the speech. In other words, each set of visemes is generated with a latency less than 100 milliseconds with reference to the successive frame of digitized analog speech information with which the set of visemes corresponds.

This is in distinct contrast to current viseme generating techniques that use conventional speech recognition technology having latencies greater than 300 milliseconds, and which therefore can only be used in situations compatible with stored speech presentation.

It will be appreciated the speech receiving device 120 may be comprised of one or more conventional processors and unique stored program instructions that control the one or more processors to implement some or all of the functions 210-265 described herein; as such, the functions 210-265 may be interpreted as steps of a method to perform viseme extraction. Alternatively, the functions 210-265 could be implemented by a state machine that has no stored program instructions, in which each function 210-265 or some combinations of certain of the functions 210-265 are implemented as custom logic. Of course, a combination of the two approaches could be used. Thus, both a method and apparatus for extracting visemes has been described herein.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means a non-empty set (i.e., for the sets defined herein, comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system.

1. A method for extracting visemes from a speech signal, comprising:
receiving successive frames of digitized analog speech information obtained from the speech signal at a fixed rate;
filtering each of the successive frames of digitized analog speech information to synchronously generate time domain frame classification vectors at the fixed rate, wherein each of the time domain frame classification vectors is derived from one of the successive frames of digitized analog speech information; and
analyzing each of the time domain classification vectors to synchronously generate a set of visemes corresponding to each of the successive frames of digitized speech information at the fixed rate.

2. The method for extracting visemes from a speech signal according to claim 1, wherein in the step of analyzing, each set of visemes is generated with a latency less than 100 milliseconds with reference to a successive frame of digitized analog speech information with which the set of visemes corresponds.

3. The method for extracting visemes from a speech signal according to claim 2, wherein the latency is less than 10 milliseconds.

4. The method for extracting visemes from a speech signal according to claim 1, wherein each set of visemes includes a subset of visemes identifiers and a one to one corresponding subset of confidence numbers.

5. The method for extracting visemes from a speech signal according to claim 1, wherein the set of visemes consists of an identity of one most likely viseme.

6. The method for extracting visemes from a speech signal according to claim 1, wherein the step of filtering comprises:
converting each of the successive frames of digitized analog speech information to a spectral domain vector using N multi-taper discrete prolate spheroid sequence basis (MTDPSSB) functions that are factors of a Fredholm integral of the first kind; and
converting each spectral domain vector to one of the time domain frame classification vectors using Inverse Discrete Cosine Transformation, wherein N is a positive integer.

7. The method for extracting visemes from a speech signal according to claim 6, wherein the conversion of each of the successive frames of digitized analog speech information to a spectral domain vector comprises:
multiplying a successive frame of digitized analog speech information by one of the N MTDPSSB functions to generate N product sets of the successive frame of digitized analog speech information;
performing a fast Fourier transform (FFT) of each of the N product sets to generate N FFT sets of the successive frame of digitized analog speech information; and
adding (change adding to combining because the addition is done to magnitude spectrums rather than separately to the real and imaginary components) together the N FFT sets of the successive frame of digitized analog speech information to generate a summed FFT set of the successive frame of digitized analog speech information.

8. The method for extracting visemes from a speech signal according to claim 1, wherein the conversion of each of the successive frames of digitized analog speech information to a spectral domain vector further comprises scaling the summed FFT set of the successive frame of digitized analog speech information.

9. The method for extracting visemes from a speech signal according to claim 1, wherein the step of analyzing comprises a spatial classification.

10. The method for extracting visemes from a speech signal according to claim 1, wherein the step of analyzing is performed by one of a neural network and a fuzzy logic function.

11. The method for extracting visemes from a speech signal according to claim 9, wherein the neural network is a feed-forward memory-less perceptron type neural classifier.

12. An apparatus for extracting visemes from a speech signal, comprising:
at least one processor; and
at least one memory that stores programmed instructions that control the at least one processor to
receive successive frames of digitized analog speech information from the speech signal at a fixed rate,
filter each of the successive frames of digitized analog speech information to synchronously generate time domain frame classification vectors at the fixed rate, wherein each of the time domain frame classification vectors is derived from one of the successive frames of digitized analog speech information, and
analyze each of the time domain classification vectors to synchronously generate a set of visemes corresponding to each of the successive frames of digitized speech information at the fixed rate.

13. A speech receiving device, comprising:
at least one processor;
at least one memory that stores programmed instructions that control the at least one processor to
receive successive frames of digitized analog speech information from a speech signal at a fixed rate,
filter each of the successive frames of digitized analog speech information to synchronously generate time domain frame classification vectors at the fixed rate, wherein each of the time domain frame classification vectors is derived from one of the successive frames of digitized analog speech information, and
analyze each of the time domain classification vectors to synchronously generate a set of visemes corresponding to each of the successive frames of digitized speech information at the fixed rate; and
a display that displays an avatar that is formed using the set of visemes.

14. An apparatus for extracting visemes from a speech signal, comprising:
means for receiving successive frames of digitized analog speech information from the speech signal at a fixed rate,
means for filtering each of the successive frames of digitized analog speech information to synchronously generate time domain frame classification vectors at the fixed rate, wherein each of the time domain frame classification vectors is derived from one of the successive frames of digitized analog speech information, and
means for analyzing each of the time domain classification vectors to synchronously generate a set of visemes corresponding to each of the successive frames of digitized speech information at the fixed rate.
